(19) United States
(12) Patent Application Publication
(10) Pub. No.: US 2016/0290306 A1
(43) Pub. Date: Oct. 6, 2016

(54) LAUNCHER AND STARTER FOR A THERMAL ENGINE

(71) Applicant: VALEO EQUIPEMENTS ELECTRIQUES MOTEUR, Creteil Cedex (FR)

(72) Inventors: Alexandre SALTEL, Bron (FR); Guillaume SEILLIER, La Verpilliere (FR); Jérémy BRANDINI, Bron (FR)

(21) Appl. No.: 15/035,143

(22) PCT Filed: Nov. 21, 2014
(86) PCT No.: PCT/FR2014/052999

§ 371 Date: May 6, 2016

(30) Foreign Application Priority Data
Nov. 21, 2013 (FR) 1361439

(51) Int. Cl. F02N 15/06

(52) U.S. Cl. CPC F02N 15/062; F02N 2015/061

(57) ABSTRACT

A starter drive assembly for a combustion engine starter having a starter ring, comprising a pinion intended to mesh with the starter ring, a driver intended to be moved by a control lever belonging to the starter, a casing constrained to rotate with the pinion and acting as a housing for at least one friction element, such as a friction disc, capable of being clamped axially between a reaction plate belonging to the casing and a pressure plate belonging to the driver, wherein it comprises a stop rigidly connected to the reaction plate in order to limit the movement of the driver and wherein axially acting elastic means with a linear characteristic curve are provided between the pressure and reaction plates to clamp the friction element. The combustion engine starter comprises such a contactor.

### FIELD OF THE INVENTION

The present invention relates to a launcher of a starter for a thermal engine with a toothed starter ring.

The present invention also relates to a starter for a thermal engine, in particular of a motor vehicle, comprising a launcher of this type.

### PRIOR ART

As described for example in documents FR 2 820 170, FR 2 787 833 and WO 2013/014385, a conventional starter for a thermal engine with a starter ring, in particular for a motor vehicle, comprises a housing which supports an electromagnetic contactor comprising a mobile core, a fixed core, a mobile element, a vessel which acts as a receptacle for at least one pull-in coil which is supported by a small coil, a cover which is rendered integral with the vessel, for example by means of crimping, and electrical contact terminals.

The housing comprises a nose, a head for support of the electric motor, and a rear bearing for closure of the head.

The vessel, the cover, the mobile core, the fixed core and the small coil have a hollow form.

As can be seen in FIG. 1 of documents FR 2 820 170 and WO 2013/014385, this starter comprises an electric motor at the rear and an output shaft at the front, on the front section of which there is fitted such as to slide a launcher which is configured to engage with the ring of the thermal engine to be started. This ring is toothed.

At the front, the launcher comprises a pinion with toothing, which toothing is for example straight, in order to engage with the complementary toothed starter ring, which can be connected in rotation in a rigid or resilient manner to the crankshaft of the thermal engine to be started. At the rear, the launcher comprises a driver which, as can be seen in FIG. 2 of documents FR 2 820 170 and WO 2013/014385, comprises a bush which has on its inner periphery helical ribbing in order to be engaged with complementary ribbing which the output shaft has locally on its outer periphery.

Because of the presence of the complementary grooves, the launcher can be displaced axially under the action of at least one actuating lever, along the output shaft, whilst being driven by movement of translation and rotation. It is mobile between a withdrawn position of rest and an advanced position of work in which it engages with the toothed starter ring. The displacement of the launcher is limited by a stop which the front section of the output shaft of the starter has.

A free wheel is interposed between the driver and the pinion. This free wheel can be disengaged, and acts like a free wheel of a bicycle. In documents FR 2 820 170 and FR 2 787 833, the free wheel is a free wheel with rollers. In document WO 2013/014385 the free wheel comprises a friction clutch.

Thus, when the output shaft of the starter rotates faster than the toothed starter ring, the free wheel is blocked. On the other hand, when this toothed ring rotates faster than the output shaft, the free wheel is released beyond a certain number of rotations per minute, in order to protect the components of the starter, in particular its electric motor.

The electric motor is accommodated in the head of the housing, and has at least two brushes which are supported by a brush-holder, and can each rub, under the action of the spring, on a collector which can be seen for example in FIG. 1 of document WO 2013/014385.

In FIG. 1 of this document WO 2013/014385 it can be seen that the electric motor comprises an output shaft which supports a wound induced rotor which is integral with the collector and is surrounded by an inductor stator. The stator can comprise a plurality of permanent magnets which are supported by the inner periphery of the head of the electric motor. As a variant, the stator is wound. This head is electrically conductive. The same applies to the nose and the rear bearing. The nose is for example a moulded part which is based on aluminium, and is designed to be secured by screws on the engine block of the motor vehicle. The housing in three parts is thus connected to the earth of the vehicle.

The nose acts as a receptacle for the launcher and for the actuating lever of the launcher, and is for example made of plastic material in order to reduce the noise. This nose is notched for penetration of the toothed starter ring inside the nose.

The head is an intermediate part which is interposed between the nose and the rear bearing, which are each configured to support a bearing for fitting with rotation respectively of the output shaft of the starter and the rear end of the output shaft of the electric motor. By way of example, it can be seen that in the aforementioned documents, the nose or bearing or front bearing of the housing supports a needle bearing for fitting with rotation of the front section of the output shaft of the starter. The bearing for fitting with rotation of the rear end of the shaft of the electric motor consists of a bearing shell for example.

The collector has a body made of electrically insulating material integral with the output shaft of the electric motor, which is knurled locally so that it can be forced into a set of plates which the rotor body has. In a known manner, this body has notches on its outer periphery for fitting for example of conductive segments in the form of copper pins which are globally in the form of a “U”, and are covered with a layer of electrically insulating enamel. The free ends of the pins are connected electrically to the collector which has electrically conductive strips for the friction of the brushes.

The output shafts of the starter and of the electric motor are aligned axially, the brushes have axial orientation, and the collector has transverse orientation relative to the axis of symmetry of the output shafts. In a known manner, as a variant, the brushes have radial orientation, and the collector has axial orientation relative to the axis of symmetry of the output shafts. In a known manner, the number of brushes can be more than two for reduction of the wear. For example, four brushes can be provided. As a variant, in severe conditions of use, it is possible to reinforce the starter and provide six or eight brushes, in particular when the starter must carry out a large number of stops and starts during its service life, particularly when the thermal engine is stopped at red lights or in traffic jams in order then to restart it, so as to save fuel, this function being known as the stop-start function.

The output shafts of the starter and the electric motor can be combined. In the FIG. 1 of the aforementioned documents, a speed reducer in the form of a planetary gear train is interposed between the front end of the shaft of the electric motor and the rear end of the output shaft of the starter. As described in document FR 2 725 758, the front end of the output shaft of the electric motor has a sun gear which engages with satellites supported by a satellite-holder which is integral with the rear end of the output shaft of the starter. These satellites engage with inner toothing which is supported by a fixed ring, for example made of plastic material, which is rendered integral by overmoulding of a metal base plate interposed between the nose of the housing and a flange which constitutes the front end of the second part of the starter. Screws are used for assembly of the nose with the base plate and a flange of the head of the housing.

The electromagnetic contactor according to the aforementioned documents extends in parallel above the electric motor. The base plate is interposed between the front end of the vessel of the contactor and the rear end of the nose. Screws are used for assembly of the nose with the base plate and the vessel. The vessel and the base plate can be electrically conductive. The contactor has an axial axis of symmetry which extends parallel to the axial axis of symmetry of the output shafts of the starter and of the electric motor.

The base plate supports an articulation projection for the rotation of the intermediate part of at least one lever for actuation of the launcher. For this purpose, the projection has an oblong hole (with no reference) for the passage of an articulation pivot integral with the lever, which is advantageously made of plastic material in order to reduce the noise. The projection is rendered integral by overmoulding with the base plate as described in the aforementioned document FR 2 725 758.

The vessel constitutes a casing, the front base of which has a central opening for guiding of the mobile core which penetrates in the vessel closed at the rear by the cover, which has at the rear a base which supports the supply terminals of the electric motor. One of the terminals is designed to be connected electrically to the positive terminal of the motor vehicle battery via a contact switch which can be actuated for example by the contact key, whereas the other terminal is designed to be connected electrically by means of a cable to the electric motor.

The mobile element comprises a shouldered control rod, which for example is made of electrically insulating material such as plastic material, and an electrically conductive mobile contact, which in this case consists of a copper plate with a globally rectangular cross-section and a central opening for passage of the rod so that it can be fitted by sliding on the rod. As a variant, the rod is made of metal and an electrically insulating sleeve is interposed radially between the central opening in the mobile contact and the outer periphery of the rod 83.

The mobile contact is mobile between an advanced position of rest, in which it is supported against the fixed core, and a withdrawn position of work in which it is in contact with the terminals, for the electrical supply of the electric motor.

The mobile core acts as a receptacle for a spring and for the rear end of a rod. This core has at the front a base which is perforated centrally for the passage of the rod, the rear end of which has a shoulder for the rear end of the spring, known as the tooth-against-tooth spring, fitted around the rod. This spring is supported by its front end on the base of the core which is closed at the rear by a washer constituting a shoulder for the rear end of the rod. This tooth-against-tooth spring permits movement of the mobile core when the pinion abuts the toothed starter ring before penetrating in the latter. A return spring is interposed axially between the base of the vessel and a flange which is integral with the front end of the mobile core.

The fixed core is fitted inside the vessel. It has centrally a hub, and at its outer periphery it has a transverse ring which is immobilised axially between a shoulder of the rear end of the vessel and the front end of the cover which has two fingers which each penetrate into an associated opening in the fixed contact ring, for blockage in rotation of the fixed contact. This fixed contact is configured to support, by means of its hub, an end of the small coil which is fitted at the rear on a bearing surface with axial orientation of the fixed core. The vessel has a reduced thickness at its free rear end for turning down of material at the level of an annular protuberance of the front end of the cover, and axial blockage of the cover and the fixed core, the rear end of which is offset forwards relative to its core ring, for formation of a cavity for accommodation of a shoulder belonging to the rod, the front end of which passes through the hub which acts as a guide for this rod. A spring, known as the contact pressure spring, is fitted on the rod, whilst being interposed axially between the shoulder of the rod and the mobile contact. This mobile contact is itself interposed axially between the contact pressure spring and a stop which is integral with the rear end of the rod. This stop also acts as a support for the front end of a return spring which is fitted on the rear end of the rod. This return spring, which is also known as the cut-off spring, is supported on the base of the cover, which has for this purpose a hollow for accommodation of the rear end of the return spring, which is less rigid than the contact pressure spring. Thus, the mobile contact is fitted with the possibility of sliding on the rear end of the rod, and penetrates into a chamber provided in the cover. This chamber can have a globally rectangular cross-section, for cooperation of forms with the mobile contact and blockage in rotation of the latter

The front end of the rod is designed to cooperate with the mobile core after elimination of play. This mobile core penetrates into the vessel and into the small coil with a central bore for this purpose.

The cores and the vessel are made of ferromagnetic material, whereas the small coil and the cover are made of electrically insulating material, such as plastic material.

The aforementioned springs can be helical springs.

The mobile core is configured to constitute an actuator for the launcher and the control rod. Thus, the mobile core is connected to the launcher by mechanical means comprising at least the lever for actuation of the launcher which is coupled at its upper end on the control rod, the front end of which supports a transverse pin, which is received in a groove formed at the upper end of this lever. This rod penetrates into the mobile core with intervention of the tooth-against-tooth spring between the rod and this core. The lower end of the lever is in the form of a fork which straddles the driver of the launcher. This fork is profiled such as to cooperate with a transverse bearing surface for control of the driver. The fork is retained at the rear by a washer with no reference, and is profiled such as to cooperate with the bearing surface. The lever has an intermediate articulation point formed by means of the projection for articulation of the base plate.

The pull-in coil, which is configured to form a solenoid, generates, for example further to actuation of the contact key, a magnetic field when an electric current passes through it, in order to displace the mobile core in the direction of the fixed core. The displacement of this mobile core gives rise to pivoting of the lever, and thus to actuation of the launcher, which is therefore displaced from its withdrawn position of rest to its advanced position of work, in which it engages with the toothed starter ring. The displacement is limited by the stop which is supported by the output shaft of the starter. In the case when the pinion does not penetrate into the starter ring, the mobile core continues its movement, with compression of the tooth-against-tooth spring.

After elimination of play, the mobile core comes into contact with the front end of the rod, in order to actuate and displace the mobile contact in the direction of the electrical supply terminals, whilst compressing the cut-off spring, in the knowledge that the contact pressure spring is more rigid than this cut-off spring. When the mobile contact is supported on the electrical contact terminals, the electric motor is supplied electrically, and makes the output shaft of the starter rotate, in all cases with penetration of the pinion into the toothed starter ring. The movement of the mobile core continues with compression of the contact pressure spring, and displacement of the rod relative to the mobile contact, until the rear end of the mobile core comes into contact with the front end, which is also chamfered, of the hub of the fixed core.

According to one embodiment, the pull-in coil is associated in a known manner with a hold-in coil which is implanted parallel to the pull-in coil and above the latter. This hold-in coil generates a magnetic field which is weaker than that of the pull-in coil. At the start of the movement of the mobile core the two coils are supplied electrically, the pull-in coil being short-circuited when the mobile contact comes into contact with the terminals, in order to reduce the electric current which is supplied by the battery. As a variant, the pull-in coil carries out the two functions of pull-in and hold-in as described in the document FR 2 795 884.

When the contact key is released, the coils are no longer supplied, and the different springs relax, as well as, optionally, the tooth-against-tooth spring, in order to return the mobile core, the mobile element and the launcher to their position of rest.

The stoppage of the thermal engine is not instantaneous as can be seen in the curve in FIG. 1, with the number of revolutions per minute (rpm) of the thermal engine on the Y-axis and the time on the X-axis. The values which are represented on the Y-axis are given in a non-limiting manner, and depend on the applications, 800 rpm being the value of the thermal engine at idling speed for an application. The phenomena are very rapid, with the times being altogether approximately 1 second.

More specifically, with reference to FIG. 2, which is identical to FIG. 1, it can be seen that there are two windows W1 and W2. In the window W1, the number of revolutions per minute of the thermal engine is positive, whereas it is positive and negative in the window W2, the thermal engine, in a manner which is known and described for example in document FR 2 631 094, to which reference will be made, being able to rotate in the inverse direction with awkward balancing phenomena.

In practice, it is necessary to wait for the thermal engine to stop completely in order to restart it. This is detrimental in particular when the motor vehicle is provided with an aforementioned stop-start function in order to save fuel.

In order to eliminate this disadvantage, it has been proposed in the aforementioned document WO 2013/014385 to provide the free wheel with a friction clutch as can be seen in FIG. 3, which is a view in cross-section of the launcher identical to FIG. 4 of the document WO 2013/014385.

In this FIG. 3, as well as in the remainder of the description, the orientations axial, radial and transverse will apply with reference to the axial axis of symmetry of the output shaft 24 of the starter, in the knowledge that this shaft passes through the launcher 1. This launcher 1 comprises a pinion 11 at the front and a driver 118 at the rear, comprising at the rear a bush 119 with axial orientation provided in its interior with helical ribbing 29 which is configured to engage with helical grooves 28 which the output shaft 24 of the starter comprises on its outer periphery. The drive bush 119 is extended by a plate 120 with transverse orientation. This plate 120 constitutes the friction clutch plate 300 comprising at least one friction element 310, such as a friction disc. The plate 120 is extended at the front by a section 121 with axial orientation which constitutes the front end of the driver 118. This section 121 is provided with grooves 122. On its inner periphery, the friction disc 301 has lugs which penetrate in a complementary manner in the grooves 122, for connection by cooperation of forms, such that the friction disc 301 is connected in rotation with the driver, and can be displaced axially relative to the driver 118. The pressure plate has an annular form.

The clutch 300 comprises a reaction plate 112 with an annular form which is integral in rotation with the pinion 11 supported by a sleeve 111 through which the shaft 24 passes with intervention of a bearing shell 124 between the outer periphery of the shaft 24 and the inner periphery of the sleeve 11 with axial orientation. The rear end of the sleeve 111 is integral with the reaction plate 112 with transverse orientation. This reaction plate 112 belongs to a casing 112, 113, 114 with an annular form comprising a skirt 113 with axial orientation which faces towards the pressure plate 120 and is connected to the outer periphery of the reaction plate 112. This skirt has grooves 322 in its inner periphery. The casing also comprises a ring 114 with transverse orientation which faces towards the interior, and is in contact with the rear face of the skirt 113. A cover 230 assembles the ring on the skirt 113. The section 121 and the reaction plate 120 penetrate into the cavity which is delimited by the casing 112, 113, 114. A return spring 400 acts between the rear face of the reaction plate 112 and the front face of the front section of the driver 118. A part 123 in the form of a “U” is fitted on the bush 119 of the driver 118. This part is dedicated to the receipt of a part for closure of the clutch 300. This part can be seen for example in FIGS. 7 and 16 of the document WO 2013/014385, to which reference will be made. This part is associated with the actuating lever of the launcher, the movement of which is controlled by the mobile core of the contactor. In the withdrawn position of rest of the launcher, play J is present in the friction clutch. The actuating lever, which is also known as the control lever, is configured to permit in a first stage axial displacement of the casing 112, 113, 114 along the axis X towards the position of engagement of the pinion with the starter ring of the thermal engine. The closure part of the clutch is configured to displace the driver 118 axially in a second stage in the direction of the reaction plate 112, in order to clamp the friction element 301 between the plates 112 and 120. The spring 400 returns the driver 118 to its return position, in order to permit rapid loosening of the latter. For further details, reference will be made to this document WO 2013/014385.

This arrangement is satisfactory because it permits engagement of the pinion 11 with the starter ring before the thermal engine stops completely, since in a first stage the pinion 11 can turn freely. The impacts and noises are reduced when the pinion 11 penetrates into the starter ring C in order to engage with the latter.

Nevertheless, it can be desirable to improve this friction clutch launcher, since it is a self-adaptive system, and the load on the friction element which is clamped between the pressure and reaction plates increases in line with the torque transmitted between the starter ring and the launcher.

### OBJECTIVE OF THE INVENTION

The objective of the present invention is to fulfil this requirement simply and economically.

According to the invention, the launcher of a starter for a thermal engine with a starter ring, of the type comprising a pinion which is designed to engage with the starter ring, a driver which is designed to be displaced by a control lever belonging to the starter, a casing which is integral in rotation with the pinion, and acts as a receptacle for at least one friction element, such as a friction disc, which can be clamped axially between a reaction plate belonging to the casing and a pressure plate belonging to the driver, is characterised in that it comprises a stop which is integral with the reaction plate, in order to limit the displacements of the driver, and in that resilient means with axial action intervene between the pressure and reaction plates in order to clamp the friction element.

According to the invention, the starter for a thermal engine of the above-described type is equipped with a launcher of this type.

By means of this arrangement, according to the invention, it is possible to make this contactor intervene in the window W1 or W2 in order to displace the launcher to its advanced position of work and engagement of the pinion of the launcher with the toothed ring of the thermal engine. This intervention is advantageously carried out for the low speeds of rotation of the thermal engine which are lower than the idling speed of this thermal engine, for example towards 50 revolutions per minute. This speed depends on the thermal engine, and is detected for example by the control unit of the thermal engine.

It will be appreciated that the friction clutch of the launcher is not modified profoundly, such that the solution is simple and economical.

In addition, there is control of the maximum load applied to the friction element inside the clutch. This maximum load defines the maximum transmission torque between the starter ring and the launcher, and reduces the stresses applied to the other parts of the starter.

In addition, thanks to the resilient means, this load varies little according to the wear.

The solution is more comfortable for the occupants of the vehicle.

According to other characteristics, taken in isolation or in combination:

The resilient means comprise at least one resilient element which is arranged around the driver, between the pressure plate and the reaction plate, and the driver and the casing integral in rotation with the pinion can go by means of the control lever from a non-compressed position, in which the casing can turn in rotation relative to the driver without torque or with minimum torque, and a torque limitation position, in which the driver abuts the casing by means of the stop, and, in the torque limitation position, the resilient means is not entirely compressed and the maximum torque transmitted between the casing and the driver is greater than the minimum torque.

Between the torque limitation position and the non-compressed position, the driver is in a state engaged with the casing, and between the torque limitation position and the non-compressed position, the maximum torque transmissible varies according to the compression of the resilient means, and is lower than the maximum torque in the torque limitation position and greater than the non-compressed position.

The at least one resilient element is arranged between a friction element and an element which is integral in rotation with the friction element, and the resilient element is supported by contact with this friction element and this element which is integral in rotation with the friction element in the engaged state.

The at least one resilient element is arranged between the pressure plate or the reaction plate and an element which is integral in rotation respectively with the pressure plate or the reaction plate.

The at least one resilient element is arranged between the pressure plate and a friction element which is integral in rotation with the pressure plate, and it is supported by contact against the pressure plate in the engaged state.

The at least one resilient element is arranged between the reaction plate and one of the friction elements which is integral in rotation with the reaction plate, and it is supported by contact against the reaction plate in the engaged state.

The element which is integral in rotation with the friction element is also a friction element.

The launcher additionally comprises a clamping disk which is integral in rotation with the casing or the driver, and the resilient means are supported by contact against this clamping disk.

The resilient means with axial action comprise two resilient elements.

The two resilient elements are fitted in series, and are in contact with one another.

The resilient means have axial action.

The resilient elements consist of at least one Belleville washer.

The resilient means are extended at their inner or outer periphery by a plurality of lugs for formation of a diaphragm.
The stop belongs to an axial projection of the reaction plate which faces towards the driver;
The stop is constituted by a shoulder formed on the axial projection of the reaction plate;
The shoulder is formed by means of a change of diameter of the projection;
The stop belongs to the free end of the axial projection;
The stop is designed to be supported on a counter-stop which belongs to the front section of the driver;
The counter-stop is formed by a shoulder which belongs to the front section of the driver;
The counter-stop is formed by a support part interposed between the stop of the reaction plate and the free end of the front section of the driver;
The counter-stop is used to support the return spring which is interposed between the reaction plate and the driver;
The resilient means with axial action comprise at least one Belleville washer;
The Belleville washer is extended on its inner periphery by a plurality of lugs for formation of a diaphragm;
The Belleville washer is supported on the reaction plate;
The Belleville washer is supported on the pressure plate;
The resilient means with axial action comprise two Belleville washers;
The two Belleville washers are fitted in series;
The two Belleville washers are fitted in series between the pressure plate and a clamping disk which is integral in rotation with the front section of the driver;
The friction clutch comprises at least two friction elements in the form of a friction disk connected in rotation to the front section of the driver;
The connection in rotation is a connection with cooperation of forms with axial movement of the friction discs;
The friction discs alternate with friction discs which are connected in rotation to the skirt of the casing, with the possibility of axial movement;
The casing and the driver are made of metal;
The starter comprises a control lever in order to act in a first stage on the casing of the launcher;
The control lever is fitted in a articulated manner at its upper end on a rod associated with the mobile core of an electromagnetic contactor which the starter comprises;
The starter comprises means for closure of the clutch which are associated with the control lever in order to act in a delayed manner on the driver;
The means for closure comprise a closure part which is coupled in an articulated manner on the lower end in the form of a fork of the control lever;
The means for closure comprise a closure part which is coupled in an articulated manner at the lower end of a supplementary lever;
The supplementary lever is configured to permit fitting of the control lever in an articulated manner between its upper and lower ends;
The closure part is configured to act in a delayed manner on the driver;
The starter is a conventional starter;
The starter is reinforced;
The starter has an outgoing pinion;
The starter is equipped with a speed reducer;
The electromagnetic contactor of the starter extends parallel to the electric motor of the starter;
The electromagnetic contactor extends perpendicularly to the axis of the electric motor.

Other advantages will become apparent from reading the description which follows in a non-limiting manner, and with reference to the appended drawings.

### BRIEF DESCRIPTION OF THE DRAWINGS

FIG. 1 is a view of a stop curve of the thermal engine with the speed of rotation of the thermal engine in revolutions per minute on the Y-axis and the time on the X-axis;

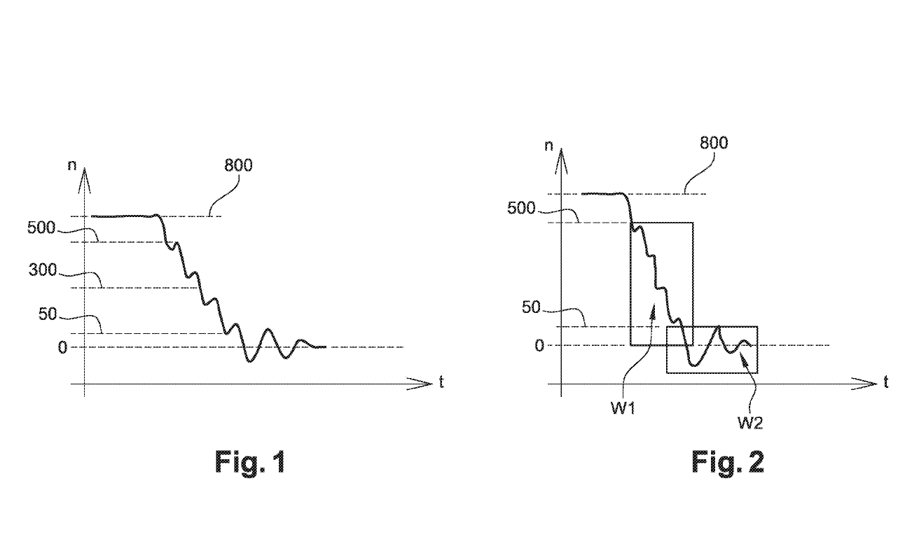

FIG. 2 is a curve identical to FIG. 1 in order to show the two, positive and balancing windows which intervene when the thermal engine stops;

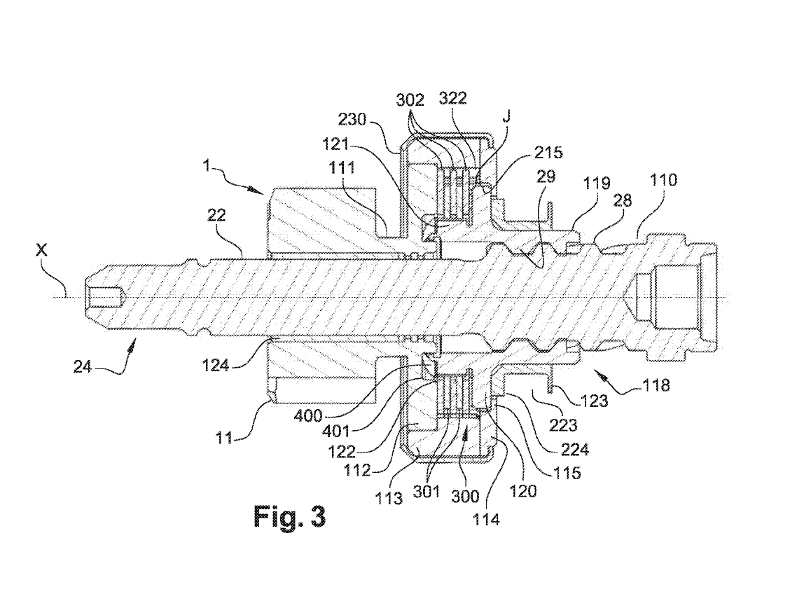

FIG. 3 is a view in axial cross-section of a launcher according to the prior art, with the presence of play within the friction clutch;

FIG. 4 is a view in axial cross-section of a starter for a thermal engine of a motor vehicle equipped with a launcher according to the invention, in the withdrawn position of rest for a first embodiment;

FIG. 5 is a view on an enlarged scale of the launcher in FIG. 4 in the withdrawn position of rest;

FIGS. 6 and 7 are view similar to those of FIGS. 4 and 5 for the advanced position of work of the launcher;

FIG. 7 is a view similar to FIG. 6 for a second embodiment of the invention.

In the figures, elements which are identical or similar will be allocated the same references.

### DESCRIPTION OF EMBODIMENTS OF THE INVENTION

For the sake of simplicity, the same references as those in document WO 2013/014385 will be used once more, the content of this document being incorporated in the present description.

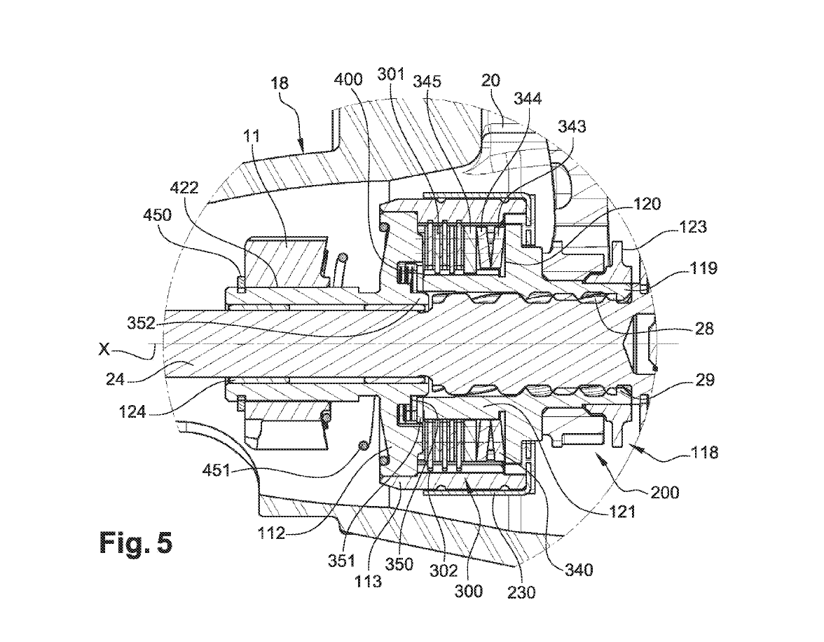

Thus, FIG. 4 shows at 4 the starter for a thermal engine, in particular for a motor vehicle.

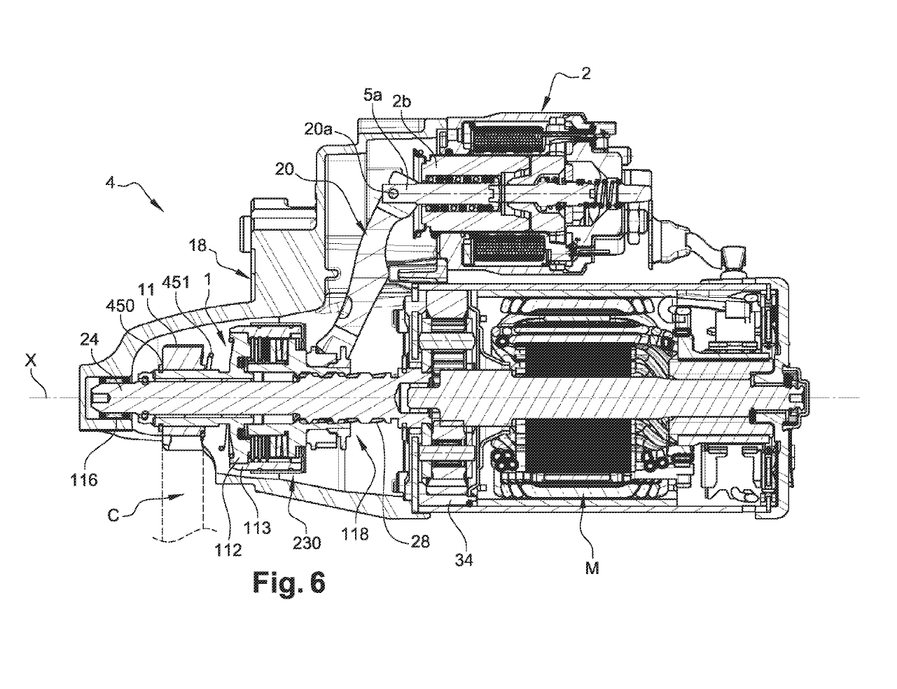

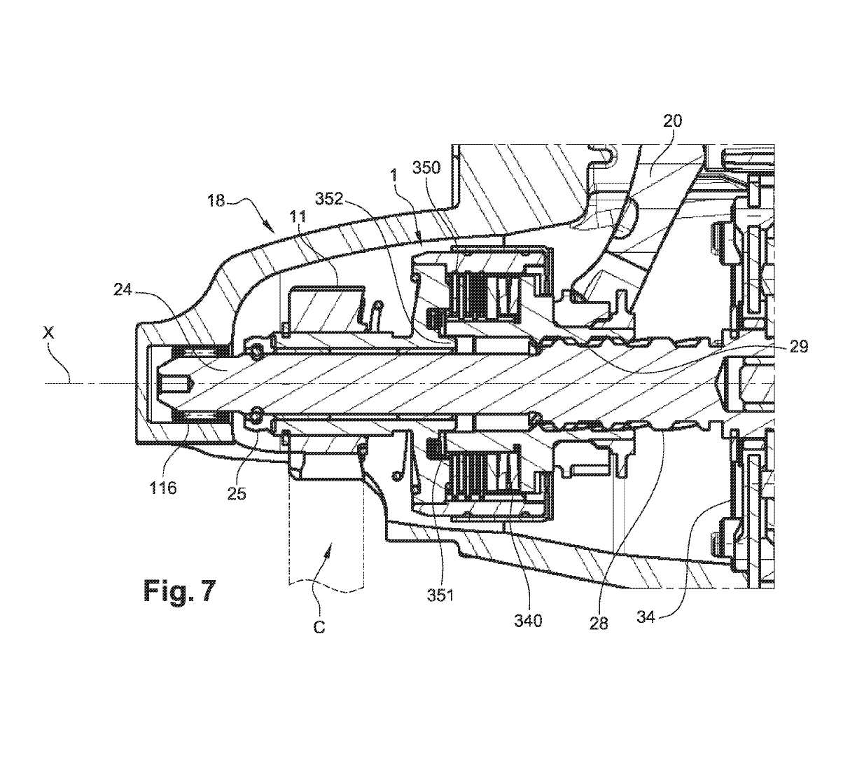

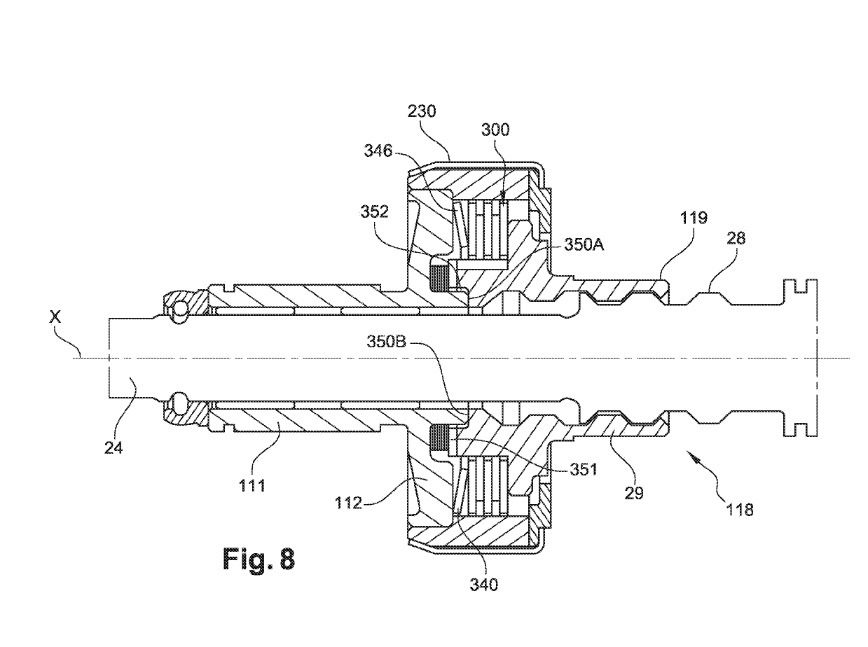

This starter 4 comprises an output shaft 24 with an axial axis of symmetry X, a launcher 1, an electromagnetic contactor 2 and an electric motor M to drive the shaft 24 when it is supplied electrically via the contactor 2. The contactor 2 is implanted above the electric motor M and parallel to the latter. This motor M is provided with an armature 14 comprising a set of plates with notches for passage of the rotor coil, the ends of which are connected to a collector (with no reference) on which there rub at least two brushes (with no reference). This motor M has an output shaft 26 with an axial axis of symmetry which is combined with the axis of symmetry X of the output shaft 24 of the starter, with intervention of a bearing 116, such as a needle bearing, between the front end of this shaft 24 and a receptacle which is provided in the nose of the starter belonging to the housing 18 of the starter. This housing also comprises a head (with no reference) for accommodation and support of the electric motor M, as well as a rear bearing (with no reference) for closure of the rear end of the head, which is closed at the front by the rear end of the nose of the starter which acts as a receptacle for the manoeuvring lever 20 of the launcher 1 provided with a pinion 11 fitted such as to be mobile on the shaft 24, between a withdrawn position of rest (FIGS. 4 and 5) and an advanced position of work (FIGS. 6 and 7), in order to engage in the manner described hereinafter with the toothed starter ring C of the thermal engine to be started. In this position of work, the pinion is supported on a stop 25 which is supported by the front end of the shaft 24, in order to limit the movement of the launcher 1. The launcher 1 is driven by a movement of translation and rotation between its withdrawn position of rest and its advanced position of work. For this purpose it has a driver 118 which is hollow in its centre, and is provided on its outer periphery with helical ribbing 28 (FIG. 7) in order to be engaged with complementary helical ribbing 29 provided on the rear end of the output shaft 24 of the starter 4.

The driver 118 can thus be displaced in translation and in rotation relative to the shaft 24.

The rear bearing has a bearing, such as a bearing shell, for fitting with rotation of the rear end of the output shaft 26 of the electric motor M. A speed reducer 34, which in this case is a planetary gear train speed reducer, is interposed in the aforementioned manner between the front end of the shaft 26 and the end of the shaft 24 which is implanted in the extension of the shaft 26. In this case, the brushes of the motor M have transverse orientation, and are designed to be connected electrically via a brush-holder (with no reference) to the electrical contact terminals of the contactor 2.

In this case, the stator 30 of the motor M is a wound stator, or as a variant a stator with permanent magnets. The contactor 2 has an axial axis of symmetry (with no reference) parallel to the axis of symmetry X.

In the aforementioned manner, the contactor 2 comprises a vessel 2d which is closed at the rear by a hollow cover 2e for accommodation of the mobile contact 3a which is designed to come into contact with the electrical supply terminals supported by the base of the cover. This mobile contact 3a belongs to a mobile element comprising a control rod 3 which is designed to be displaced axially by the mobile core 2b which also constitutes an actuator for the control lever 20 of the driver, which is fitted in an articulated manner on its upper end on a shaft 20a (FIG. 4), such as a pin, which is fitted in the rear end of a rod 5a with intervention of the tooth-against-tooth spring 5 fitted in the mobile core between the rear end of the rod 5a and the base of the mobile contact 2b

The lower end of the lever 20 is in the form of a fork fitted on a bush 119 which the lower end of the driver 118 comprises. The lever 20 has a connection portion (with no reference) between its upper and lower ends. This portion supports pivots for fitting in an articulated manner, for example on an extension of the ring of the reducer 34, as described in document FR 2 863 018 to which reference will be made. As a variant, fitting in an articulated manner with projection of a base plate can be carried out.

The reference 2a designates the pull-in and hold-in coils which are fitted via a small coil (with no reference) on a bearing surface of the fixed core 2f through which the rod 3 passes.

The springs 6a, 6b, 6c are respectively the cut-off spring, the tooth-against-tooth spring, and the return spring of the mobile core.

For the functioning of the starter and its contactor, reference will be made to the introduction, as well as for example to document FR 2 895 143, which describes a fitting of the bayonet type between the mobile contact at 3a and the control rod 3. This type of fitting is applicable to the starter in FIG. 4.

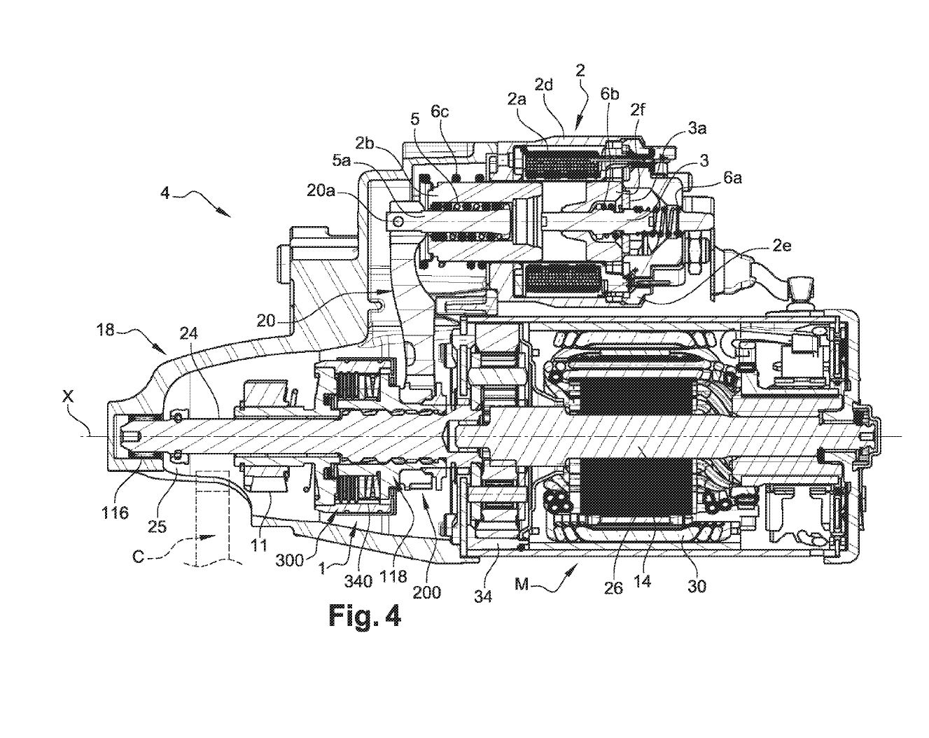

In the embodiments according to the invention, there is no profound modification of the structure of the launcher 1 in FIG. 3, such that the solution is simple and economical.

More specifically, according to the invention, the launcher 1 of the starter for a thermal engine with a starter ring C, of the type comprising a pinion 11 which is designed to engage with the starter ring C, a driver 118 which is designed to be displaced by a control lever 20 belonging to the starter, a casing 112, 113, 230 which is integral in rotation with the pinion 11, and acts as a receptacle for at least one friction element 301, such as a friction disc, which can be clamped axially between a reaction plate 112 belonging to the casing 112, 113, 230 and a pressure plate 120 belonging to the driver, is characterised in that it comprises a stop which is integral with the reaction plate, in order to limit the displacements of the driver, and in that resilient means with axial action and a linear characteristic curve 340 (force exerted according to the displacement) intervene between the pressure and reaction plates in order to clamp the friction element.

The number of friction elements 301 depends on the applications and on the torque transmitted between the ring C and the launcher 1. Increasing the number of friction elements reduces the size of the casing.

Thanks to the supplementary resilient means and the stop, the value of the torque transmitted is controlled. Starting with a specific or predetermined torque, the clutch 300 slips, such that the other components of the starter 4 are protected.

As can be seen better in FIGS. 5 and 7, the configuration of FIG. 3 is retained, with the addition of the stop and resilient means with axial action with a linear characteristic curve (load exerted according to the displacement).

Thus, in FIGS. 4 to 8, the elements which are common with those in FIG. 3 will not be described again in detail.

In these figures:

The friction clutch 300 comprises at least two friction elements 301 in the form of a friction disc connected in rotation to the front section 121 of the driver;

The connection in rotation is a connection with cooperation of forms with axial movement of the friction discs 301;

The friction discs 301 alternate with friction discs 302 which are connected in rotation to the skirt 113 of the casing 112, 113, 230, with the possibility of axial movement;

The casing and the driver are made of metal;

The starter 4 comprises a control lever 20 in order to act in a first stage on the casing of the launcher 1;

The control lever 20 is fitted in a articulated manner at its upper end on a rod 5a associated with the mobile core 2b of an electromagnetic contactor 2 which the starter 4 comprises;

The starter comprises means for closure of the clutch 300 which are associated with the control lever in order to act in a delayed manner on the driver;

The means for closure comprise a closure part 200 which is coupled in an articulated manner on the lower end in the form of a fork of the control lever;

The means for closure comprise a closure part which is coupled in an articulated manner on the lower end of a supplementary lever;

The supplementary lever is configured to permit fitting of the control lever in an articulated manner between its upper and lower ends;

The closure part is configured to act in a delayed manner on the driver;

The number of friction elements 301, 302 depends on the applications and on the torque transmitted between the ring C and the launcher 11. Advantageously, these elements 301, 302 comprise a metal part which is covered with at least one friction lining with the appropriate coefficient of friction.

For further details of these different characteristics, reference will be made to this document WO 2013/014385. During the first stage, i.e. passage from the withdrawn position of rest to the advanced position of work, the pinion can turn freely and engage with the ring C. In the second stage, i.e. intervention of the means for closure of the clutch, the driver is displaced as far as the stop. Then, the load which is exerted on the friction element(s) is controlled and remains substantially constant because the resilient means with axial action have a linear characteristic curve. However the resilient means with axial action have a non-linear characteristic curve.

These resilient means 340 comprise at least one Belleville washer. By selecting a load which is close to the top of this curve, a clamping load exerted is obtained which varies little according to the wear.

This Belleville washer can be extended on its inner periphery by lugs in order to form a diaphragm.

This Belleville washer, which has a frusto-conical form in the free state, is an economical part.

According to one embodiment, it is possible to provide two Belleville washers fitted in parallel in order to increase the loads exerted. However, this solution leads to reduction of the course which is possible in comparison with a single Belleville washer.

It is preferable to fit the two Belleville washers in series as in FIGS. 4 to 7 in order to increase the deformations possible. More specifically, the load which is exerted by these Belleville washers with a frusto-conical form is the same as that of one Belleville washer, but the deflections of these two washers are added together.

In FIGS. 5 to 7, as in FIGS. 12 and 13 of this document WO 2013/014385, the pinion 11 is connected in rotation to the sleeve 111, with the possibility of axial movement by means of fitting with complementary grooves 422 with axial orientation, and a spring 451 on the pinion 11 and on the reaction plate 112, in order to limit the noise when the pinion 11 is supported on the toothed ring, without penetrating into the latter. A stop 450 in the form of a circlip limits the displacement forwards of the pinion 11. A return spring 400 is also provided, which acts between the reaction plate and the front section 121 of the driver 118, in order to return the driver 118 rapidly to its position of rest.

The spring 451 has a frusto-conical form, and is supported on the front face of the reaction plate by means of a hollow provided in this face.

The motor vehicle can advantageously be provided with the stop-start function for its thermal engine comprising the starter when the vehicle is first put into use or subsequently. The stop-start function makes it possible to save fuel by stopping the thermal engine when the vehicle arrives at red lights, or in traffic jams.

The starter can be a reinforced starter, with for example a larger number of brushes, or it can be a conventional starter, with for example only four brushes, in particular when the stop-start function of the vehicle is installed subsequently.

In order to stop the thermal engine, this stop-start function can make the speed of the motor vehicle intervene, for example when the speed drops to 6 km an hour, as well as the position of the brake pedal, in particular when the gearbox of the motor vehicle is a manual gearbox.

As a variant, the stop-start function can make the position of the gear lever intervene, as well as the position of the clutch pedal.

In another variant, the stop-start function can make the position of the gear lever and the position of the accelerator pedal intervene, in particular when the gearbox of the vehicle is automatic.

According to these different pieces of information, the stop-start function can be inhibited, in a known manner.

It is thus possible to engage the pinion in the ring C before the thermal engine stops completely, and to restart more rapidly.

In all cases, the solution according to the invention is less noisy.

### First Embodiment in FIGS. 4 to 7

In this embodiment, the stop 350 belongs to an axial projection 352 of the reaction plate which faces towards the driver 118. This stop 350 extends axially on the inner periphery of the reaction plate 112, and in the extension of the sleeve 111 with intervention of bearing shells 124 between the smooth outer periphery of the front part of the shaft 24, and the inner periphery of the sleeve 111. The stop 350 is constituted by a shoulder which is formed on the axial projection 352 of the reaction plate 112.

The plate 112, which has an annular form, is notched on its inner periphery on the exterior of the projection 352 for accommodation of the return spring 400 which acts between the base of the notch and a washer 351 which is in contact with the free end of the front section 121. The free end of the projection 352 extends inside the projection 121, and penetrates slightly into the latter in order to reduce the axial size in combination with the notch in the reaction plate. The shoulder 350 is formed by means of a change of diameter of the projection 352, such that the free end with a reduced diameter of the projection 352 extends inside the section 121, and penetrates slightly into the latter. The shoulder 350 is opposite the free end of the section 121 with an annular form.

The stop 350 is designed to be supported against a counter-stop which the front section of the driver has.

The counter-stop is formed by a support part, in this case the washer 351, which is interposed between the stop of the reaction plate and the free end of the front section 121 of the driver 118. The counter-stop acts as a support for the return spring 400 which is interposed between the reaction plate and the driver. This washer 351 is fitted on the portion with a reduced diameter of the free end of the projection 352. It is centred by this portion with a reduced diameter, and has characteristics which make it possible to reduce the wear and noise between the return spring 400 and the free end of the front section 121.

The resilient means 350 comprise two Belleville washers 343, 344 which are fitted in series. These washers 343, 344 act between a thick clamping washer 345 and the front face of the pressure plate 120 which has an annular form and an outer diameter which is smaller than that of the reaction plate 112, and is globally equal to the inner diameter of the skirt 113 connected to a cover 230 with a return which faces radially towards the axis X. This return replaces the plate 114 in FIG. 3. The pressure plate 120 thus penetrates into the casing 112, 113, 230. The clamping washer 345 is connected in rotation to the front section, with the possibility of axial movement by means of the outer grooves (with no reference) which the section 121 has on its outer periphery, for connection in rotation with axial movement of the two friction discs 301, which alternate with three friction discs 302 connected in rotation to the skirt 113, with the possibility of axial movement by means of the inner grooves (with no reference) of the skirt 113. Two of the discs 302 are in contact respectively with the rear face of the reaction plate and the front face of the clamping washer.

### Second Embodiment in FIG. 8

A single Belleville washer 346 is provided. It acts between the rear face of the reaction plate 112 and the front face of the adjacent washer 302. The stop 350A for limitation of the axial movement of the driver is constituted by the rear free end of the projection 352. The counter-stop is formed by a shoulder 350B which the section 121 has on its inner periphery at its free end.

### Other Embodiments

The pinion 11 can be integral in rotation and axially with the sleeve 111 which can have a reduced length axially.

In FIGS. 4 to 7, it is possible to eliminate the washer 351, such that the counter-stop is formed by the free end of the front section 121.

It is possible to invert the fitting of the washers 354, 344, 343 in FIGS. 4 to 7, which can be supported on the reaction plate 112.

In these FIGS. 4 to 7, a single Belleville washer can be provided.

Two Belleville washers fitted in series can be provided in FIG. 8.

Different variants can be provided for the friction discs 301, 302, which advantageously have friction linings as described in this application WO 2013/014385. The same applies to the constitution of the casing.

### Applications

It is apparent from the foregoing description that the launcher according to the invention belongs to a starter with an electric motor and electromagnetic contactor. This launcher is configured to engage with a toothed starter ring of the thermal engine to be started, such as the thermal engine of a motor vehicle. The other components of the starter can be retained.

In the aforementioned manner, this starter can be a conventional starter or a reinforced starter, and can form part of the stop-start function of the vehicle. It can be reinforced at the level of the output shaft, and have for example two bearings for support of this shaft. It can comprise at least 6 brushes.

This starter can have other embodiments.

Thus, as a variant, the contactor can be implanted below the starter, or it can be offset as described whilst being implanted at the rear of the starter by means of a return mechanism with a return rod and bent return lever as described for example in document FR 2 843 427 to which reference will be made.

The vessel of the contactor can be in several parts, for example in three parts as described in document EP 1 613 858.

As a variant, the pull-in and hold-in coils are combined, and the duty cycle of the current is varied as described in document FR 2 795 884, to which reference will be made.

The pinion can be an outgoing pinion implanted on the exterior of the nose, as described for example in document FR 2 745 855. The toothing of the pinion and of the starter ring can be inclined, as described in the aforementioned document FR 2 820 170.

As a variant, the base plate is eliminated, the lever 20 and the speed reducer being arranged as described in documents DE 28 22 165, FR 2 787 833 or FR 2 863 018 to which reference will be made.

As a variant, in the light of document, FR 2 787 833, resilient means with circumferential action, such as studs, are implanted in the kinematic chain which goes from the pinion 11 to the shaft 26 of the electric motor M.

The output shaft 24 can be offset radially relative to the shaft 26 of the electric motor, with the presence of a gear train between the rear end of the output shaft 24 and the front end of the shaft 26 of the electric motor M.

As a variant, the shaft 24 is combined with the shaft 26, such that the speed reducer is eliminated.

In the aforementioned manner, the number of brushes can be at least equal to 6 or 8. For example, the brushes can have radial orientation and can be implanted in pairs on both sides of a brush-holder plate. As a variant, the brushes have axial orientation.

In the aforementioned manner, the starter can belong to an electric circuit of a motor vehicle which is provided with the stop-start function.

The electromagnetic contactor 2 of this starter can be controlled by a micro-controller, such as that of the engine control unit which the motor vehicle comprises.

It will be appreciated that the speed of rotation of the thermal engine can be determined by means of at least one sensor at the level of the ring C.

1. Launcher (1) of a starter (4) for a thermal engine with a starter ring (C), of the type comprising a pinion (11) which is designed to engage with the starter ring (C), a driver (118) which is designed to be displaced by a control lever (20) belonging to the starter (4), a casing (112, 113, 230) which is integral in rotation with the pinion (11), and acts as a receptacle for at least one friction element (301), such as a friction disc, which can be clamped axially between a reaction plate (112) belonging to the casing (112, 113, 230) and a pressure plate (120) belonging to the driver (118), wherein it comprises a stop (350, 350A) which is integral with the reaction plate, in order to limit the displacements of the driver, and in that resilient means (340) with axial action intervene between the pressure and reaction plates in order to clamp the friction element.

2. Launcher (1) according to claim 1, wherein the resilient means comprise at least one resilient element which is arranged around the driver, between the pressure plate and the reaction plate, and wherein the driver and the casing (112, 113, 230) integral in rotation with the pinion (11) can go by means of the control lever from a non-compressed position, in which the casing can turn in rotation relative to the driver without torque or with minimum torque, and a torque limitation position, in which the driver abuts the casing by means of the stop (350, 350A), and wherein, in the torque limitation position, the resilient means is not entirely compressed and the maximum torque transmitted between the casing and the driver is greater than the minimum torque.

3. Launcher (1) according to claim 1, wherein, between the torque limitation position and the non-compressed position, the driver is in a state engaged with the casing, and wherein, between the torque limitation position and the non-compressed position, the maximum torque transmissible varies according to the compression of the resilient means, and wherein it is lower than the maximum torque in the torque limitation position and greater than the non-compressed position.

4. Launcher (1) according to claim 2, wherein the at least one resilient element is arranged between the pressure plate or the reaction plate and an element which is integral in rotation respectively with the pressure plate or the reaction plate.

5. Launcher (1) according to claim 3, wherein the at least one resilient element is arranged between the pressure plate and a friction element which is integral in rotation with the pressure plate, and wherein it is supported by contact against the pressure plate in the engaged state.

6. Launcher (1) according to claim 3, wherein the at least one resilient element is arranged between the reaction plate and one of the friction elements which is integral in rotation with the reaction plate, and wherein it is supported by contact against the reaction plate in the engaged state.

7. Launcher (1) according to claim 3, comprising a clamping disk (345) which is integral in rotation with the casing or the driver, and wherein the resilient means are supported by contact against this clamping disk.

8. Launcher (1) according to claim 1, wherein the resilient means with axial action (340) comprise at least one Belleville washer.

9. Launcher (1) according to claim 1, wherein the resilient means are extended at their inner or outer periphery by a plurality of lugs for formation of a diaphragm.

10. Launcher (1) according to claim 1, wherein the stop (350, 350A) belongs to an axial projection (352) of the reaction plate (112) which faces towards the driver (118).

11. Launcher (1) according to claim 10, wherein the stop (350, 350A) is constituted by a shoulder formed on the axial projection (352) of the reaction plate (112).

12. Launcher (1) according to claim 10, wherein the stop (350A) belongs to the free end of the axial projection (352).

13. Launcher (1) according to claim 1, wherein the stop (350, 350A) is designed to be supported on a counter-stop (351, 350B) with a front section (121) which the driver (118) comprises.

14. Launcher (1) according to claim 13, wherein the counter-stop is formed by means of a shoulder (350B) which belongs to the front section (121) of the driver (118), and wherein the counter-stop is formed by a support part (351) interposed between the stop (350) of the reaction plate (112) and the free end of the front section (121) of the driver (118).

15. Starter comprising a launcher according to claim 1.

16. Launcher (1) according to claim 2, wherein, between the torque limitation position and the non-compressed position, the driver is in a state engaged with the casing, and wherein, between the torque limitation position and the non-compressed position, the maximum torque transmissible varies according to the compression of the resilient means, and wherein it is lower than the maximum torque in the torque limitation position and greater than the non-compressed position.

17. Launcher (1) according to claim 4, comprising a clamping disk (345) which is integral in rotation with the casing or the driver, wherein the resilient means are supported by contact against this clamping disk.

18. Launcher (1) according to claim 5, comprising a clamping disk (345) which is integral in rotation with the casing or the driver, wherein the resilient means are supported by contact against this clamping disk.

19. Launcher (1) according to claim 6, comprising a clamping disk (345) which is integral in rotation with the casing or the driver, wherein the resilient means are supported by contact against this clamping disk.
